(19) United States
(12) Patent Application Publication
(10) Pub. No.: US 2025/0246082 A1
(43) Pub. Date: Jul. 31, 2025

(54) SYSTEM AND METHOD FOR ENERGY-AWARE FLIGHT MISSION PLANNING AND CONTROL

(71) Applicant: Microavia International Limited, Dublin (IE)

(72) Inventor: Dmitry Popov, Dubai (AE)

(21) Appl. No.: 18/427,040

(22) Filed: Jan. 30, 2024

(51) Int. Cl. G08G 5/00

(52) U.S. Cl. CPC G08G 5/34; G08G 5/26; G08G 5/55; G08G 5/57; G08G 5/74; G08G 5/76

(57) ABSTRACT

Systems and methods for energy-aware flight mission planning and control in unmanned aerial vehicles. The system includes a flight control center with machine learning-based modules for path planning and weather analysis, ensuring optimal routes considering energy consumption and weather conditions. Dynamic programming allows for the calculation of energy-efficient 3D paths. This approach allows for adaptable mission planning, offering alternative paths, and real-time adjustments based on telemetry data and weather predictions. UAV mission efficiency and safety is enhanced, improving unmanned aerial vehicle operations.

### TECHNICAL FIELD

The invention relates generally to energy-aware flight mission planning and control for unmanned aerial vehicles (UAVs). More particularly, the invention relates to optimizing flight missions based on real-time weather data, predictive models and further, to adaptive flight control.

### BACKGROUND

UAVs have found extensive applications in various fields, including surveillance, agriculture, and delivery services. However, UAV operational efficiency is hampered by the critical challenge of effectively managing energy consumption during flight missions. Such a challenge is exacerbated by the unpredictable nature of weather conditions, suboptimal flight planning methods, limitations in ground control station adaptability, and complexities in battery management.

Weather conditions significantly affect UAV energy consumption, and sudden and unpredictable changes in weather patterns, such as gusty winds or unforeseen storms, can disrupt mission progress. Existing UAV systems often struggle to adapt promptly to these dynamic conditions, resulting in inefficient energy utilization. For instance, a UAV engaged in a search and rescue mission may encounter unexpected weather shifts, which not only put into risk mission success but also compromises UAV safety.

Existing flight planning approaches fail to account for factors that could lead to energy-efficient flight paths and optimal geographical coverage. Such oversight can lead to situations where UAVs either return with surplus battery charge or fail to cover critical areas due to energy limitations. For example, an agricultural UAV may consume more energy than necessary, resulting in reduced coverage of the monitored field.

Ground control stations are essential components in guiding UAVs during missions. Nevertheless, a significant drawback is that many of these stations are static and pre-established based on predetermined mission parameters. Consequently, they become less effective when faced with changing conditions, such as shifting weather patterns or modified operational requirements. For example, a static control station used in a wildfire response mission may lose its effectiveness as the fire's location changes.

Effective battery management remains a persistent challenge for UAVs, primarily relying on battery power. Inefficient battery management systems can lead to overestimation or underestimation of available energy, resulting in mission inefficiencies or premature returns to base for recharging. In the context of a delivery UAV, these issues could lead to mission interruptions and delivery delays.

Safety is a paramount concern, especially when UAVs operate in unpredictable environments, such as remote areas or during emergency response missions. Ensuring safe task completion and a successful return to base in these scenarios remains a significant challenge.

Therefore, there is a need for improved systems and methods to optimize energy-aware flight mission planning and control for Unmanned Aerial Vehicles.

### SUMMARY

The present disclosure relates to systems and methods for energy-aware flight mission planning and control for unmanned aerial vehicles (UAVs). More particularly, embodiments relate to optimizing flight missions based on real-time weather data, predictive models and further, to adaptive flight control.

The embodiments described herein improve energy-aware flight mission planning and control for Unmanned Aerial Vehicles. By integrating advanced machine learning models and dynamic programming approaches, this system optimizes UAV flight paths based on real-time telemetry, weather predictions, and energy consumption patterns. The system plans energy-efficient flight missions and dynamically adapts them, ensuring energy efficiency and safety in diverse conditions.

In an embodiment, a method for energy-aware flight mission planning and control in Unmanned Aerial Vehicles (UAVs) comprises collecting telemetry data from UAVs, weather data related to flight mission location, and terrain data of flight mission location from data sources; training a plurality of machine learning models (MLs) based on the collected data including a mission planning ML model, a weather prediction ML model, and an energy consumption ML model, wherein each of the plurality of ML models is configured to generate a prediction; planning a flight mission for a first UAV based on the collected data and predictions of the plurality of machine learning models, the mission commencing from a first ground control station; controlling telemetry parameters of the first UAV during the flight mission, the telemetry parameters including energy consumption; and adjusting the flight path of the first UAV based on the controlled telemetry parameters and predictions to complete the flight mission.

In one aspect, adjusting the flight path of the first UAV further comprises redirecting the first UAV to a second ground control station for completing the mission.

In one aspect, adjusting the flight path of the first UAV further comprises initiating a stop at the second ground control station for recharging the first UAV.

In one aspect, adjusting the flight path of the first UAV further comprises adjusting the position of the first ground control station.

In one aspect, the method further comprises collecting telemetry data from a second UAV, and using the collected telemetry data from the second UAV to adjust the flight mission of the first UAV.

In one aspect, the collected data includes data related to wind speed, wind direction, atmospheric pressure, temperature, humidity, terrain elevation and terrain zones.

In one aspect, the mission planning unit employs a dynamic programming approach for optimizing flight paths.

In one aspect, the energy consumption ML model includes a sub-model for determining the feasibility of completing the mission with available battery charge.

In one aspect, the energy consumption ML model includes a sub-model for optimizing flight mode parameters, including at least one of speed, acceleration, altitude, or payload configuration.

In one aspect, the method of claim 1, further comprising adjusting the altitude of the first UAV during the flight mission based on weather prediction specific to different altitude levels.

In one aspect, the telemetry data from UAVs comprises motor power for wind extraction.

In an embodiment, a system for energy-aware flight mission planning and control in Unmanned Aerial Vehicles (UAVs) comprises: a flight control center; data sources, comprising real-time weather data and terrain data; a first ground control station configured to communicate with, recharge, and shield UAVs; and a first UAV, configured to perform flight missions according to planned flight missions, adjust flight missions based on the telemetry data, the weather conditions, and the energy consumption predictions, and communicate with the first ground control station and the flight control center. The flight control center, includes a mission control unit configured to control telemetry data from the first UAV and manage mission parameters for the first UAV; a mission planning unit configured to plan flight missions for the first UAV based on weather data, terrain data, and energy consumption predictions; a weather analysis unit configured to analyze real-time weather data and predict weather conditions relevant to the flight missions; and an operation optimization unit, configured to optimize flight mode parameters, including speed, acceleration, altitude, and payload configuration, using machine learning models;

In an embodiment, the system further comprises a second ground control station, and the flight control center, configured to redirect the first UAV to the second ground control station to complete a flight mission.

In an embodiment, the system further comprises a second ground control station, and the flight control center is configured to initiate a stop on the second ground control station for recharging the first UAV during a flight mission.

In an embodiment, the first ground control station is configured to adjust its position.

In an embodiment, the system further comprises a second UAV configured to collect telemetry data and communicate with the Flight Control Center to adjust the flight mission of the first UAV.

In an embodiment, the mission planning unit implements a machine learning model for path generation that employs reinforcement learning techniques for optimizing flight paths.

In an embodiment, the mission planning unit implements a machine learning model for energy consumption prediction configured for determining the feasibility of completing the flight mission with available battery charge.

In an embodiment, the mission planning unit implements a machine learning model for energy consumption prediction configured for optimizing flight mode parameters, including at least one of speed, acceleration, altitude, or payload configuration.

In an embodiment, the mission planning unit implements a machine learning model for weather prediction configured to predict weather parameters specific to different altitude levels.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a block diagram of a system for energy-aware flight mission planning and control, in accordance with an embodiment.

FIG. 2 is a detailed block diagram of a system for energy-aware flight mission planning and control, in accordance with an embodiment.

FIG. 3 is a block diagram of a Flight Control Center, in accordance with an embodiment.

FIG. 4 is a schema of UAV path adjustment during a flight mission, in accordance with an embodiment.

FIG. 5 is a schema of adaptive flight mode adjustment, in accordance with an embodiment.

FIG. 6 is a flowchart of a method for energy-aware flight mission planning and control, in accordance with an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

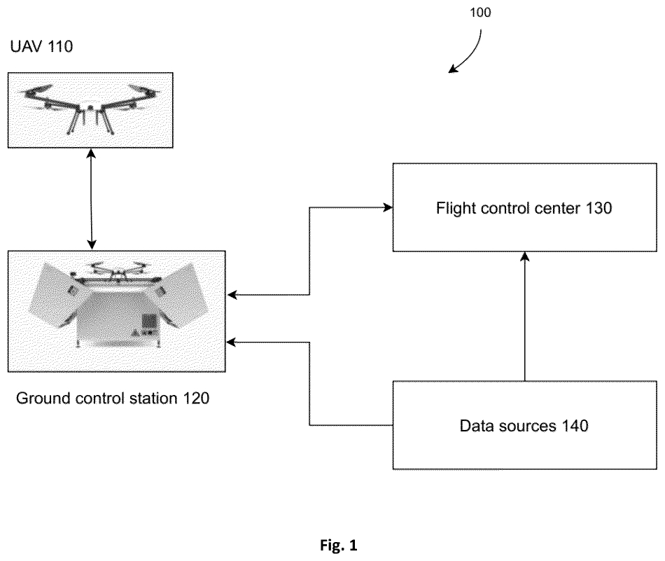

FIG. 1 shows a block diagram of a system for energy-aware flight mission planning and control in UAVs, in one embodiment. In this embodiment, the system 100 comprises a UAV 110, a Ground Control Station 120, a Flight Control Center 130, and Data Sources 140.

In one embodiment, the UAV 110 is a component of the system responsible for executing flight missions. The UAV 110 is equipped with telemetry data sensors, communication modules, and various payloads. The UAV 110 can be a quadcopter, fixed-wing aircraft, or any other unmanned aerial vehicle. The UAV 110 communicates bidirectionally with the Ground Control Station 120 and, optionally, with the Flight Control Center 130, receiving mission instructions and relaying telemetry data and status updates.

The Ground Control Station (GCS) 120 serves as the interface between an operator and the UAV 110. In one embodiment, the Ground Control Station 120 can function as a mobile unit, installed on a moving platform or vehicle, allowing for dynamic repositioning to better align with mission requirements. In another embodiment, multiple UAVs can operate independently or cooperatively as a flock or group, with each UAV being managed by one or more GCS. The GCS 120 establishes a connection with the Flight Control Center 130 to transmit mission parameters and telemetry data, among other data.

The Flight Control Center (FCC) 130 is a unit responsible for mission planning and coordination. In one embodiment, the FCC 130 can be integrated as a functional module within the Ground Control Station 120. Alternatively, the FCC 130 can be a dedicated server or computing cluster connected to multiple GCSs 120 and UAVs 110. In another embodiment, FCC 130 can be implemented as a functional module of the UAV 110. In yet another embodiment, FCC 130 functionality can be distributed or reserved between the UAV 110, the GCS 120 and dedicated server of the FCC 130. In this case, the UAV 110 can control and predict flight parameters, plan flight missions if the connection to the FCC 130 server or to the GCS 120 is lost or poor. The FCC 130 utilizes real-time climate data (referred to as weather data) from Data Sources 140, predictive models, and adaptive flight control algorithms to optimize mission parameters, including the flight path, speed, and altitude. Such data utilization ensures energy-efficient flight missions in dynamic weather conditions.

Data Sources 140 are external data providers that feed real-time climate data to the FCC 130. In one embodiment, Data Sources 140 include weather stations, meteorological databases, and environmental sensors. In one embodiment, Data Sources 140 represents a database that stores data collected from data providers. In another embodiment, the Data Sources represent connectors to external storages, services or databases of data providers, that provide updated data. The climate data can include information such as wind speed, wind direction, atmospheric pressure, temperature, and humidity. By integrating data from Data Sources 140, the FCC 130 can make informed decisions to adapt flight missions dynamically. In one embodiment, Data Sources 140 include data from the UAVs 110.

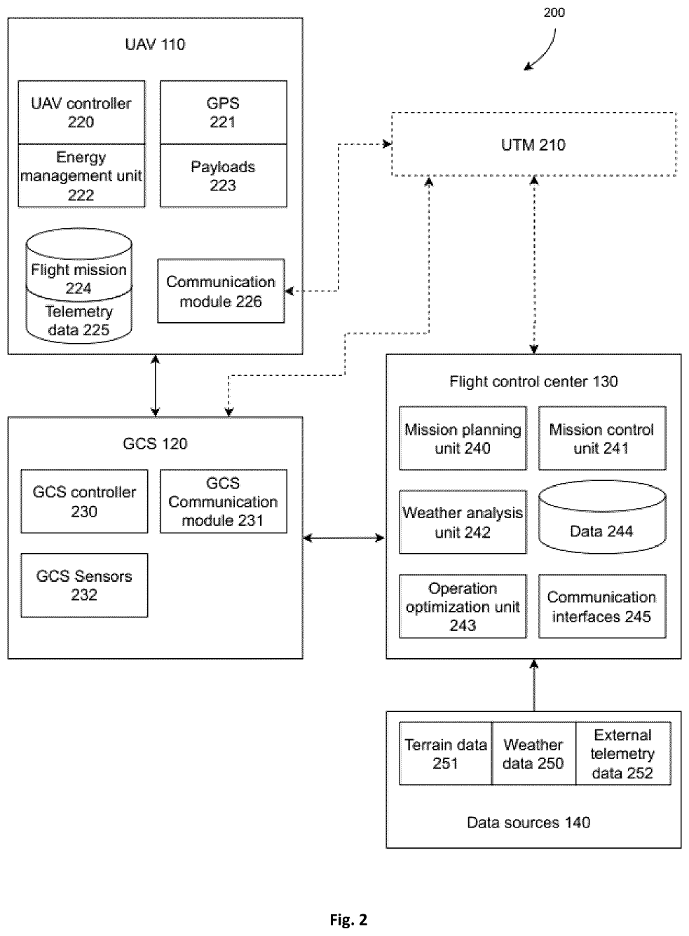

FIG. 2 shows a detailed block diagram of a system for energy-aware flight mission planning and control in UAVs, in one embodiment. FIG. 2 and its description illustrates the specific components within each block of FIG. 1, including depiction and description of respective component functionalities. In such embodiment, the system 200 comprises a UAV 110, a Ground Control Station (GCS) 120, a Flight Control Center (FCC) 130, Data Sources 140, and introduces the Unmanned Traffic Management (UTM) system 210.

The UAV 110 includes several components facilitating its operations: a UAV controller 220, a GPS unit 221, an energy management unit 222, various payloads 223, a storage unit for telemetry data 225, a communication unit 226, and a storage unit for flight missions 224. These components collectively enable the UAV to execute flight missions efficiently.

The UAV Controller 220 serves as the core intelligence of the UAV 110. The UAV Controller 220 manages flight operations, executes mission commands, and ensures coordinated actions of various UAV subsystems. The UAV Controller 220 is responsible for interpreting mission instructions received from the Ground Control Station 120 or Flight Control Center 130 and translating such instructions into specific flight actions. The UAV Controller 220 communicates with GPS 221 and energy management unit 222 to optimize flight parameters, ensuring efficient energy usage during missions. In one embodiment, the UAV controller 220 controls power consumption by each motor of the UAV 110, referred to as motor power for wind extraction, at each time of the flight. The power consumption as a function of time, weather parameters, altitude and/or geoposition coordinates is used to adjust weather prediction and power consumption predictions. For example the wind can be estimated using the power spent at each motor to stabilize the UAV 110 and to move the UAV 110 along the path. In another embodiment, the UAV controller 220 communicates with GPS 221, and optionally inertial measurement unit (IMU), compass and barometric sensors (not shown) to control the flight and localize the UAV in a space.

The GPS Unit 221 provides precise geospatial information, including the positon, altitude, and velocity of the UAV 110n. The GPS Unit 221 is an essential component for navigation, enabling the UAV 110 to follow predefined flight paths accurately. The GPS Unit 221 allows the system to track the location of the UAV 110 in real-time and is utilized for mission planning, route adjustments, and ensuring compliance with airspace regulations.

The Energy Management Unit 222 is utilized in monitoring and managing the power resources of the UAV 110. The Energy Management Unit 222 can evaluate the energy consumption of various subsystems, including propulsion, avionics, and payloads. By optimizing power distribution and usage, the energy management unit 222 helps extend the operational endurance of the UAV 110 and ensures that the mission can be completed within available battery capacity. The Energy management unit 222 tracks energy consumption in accordance with UAV flying mode, time, geoposition, operated tasks of flight mission, speed and other external parameters, and enables analysis of these data within FCC 130.

Payloads 223 encompass various sensors, cameras, or specialized equipment mounted on the UAV 110 for specific mission objectives. Payloads 223 can include high-resolution cameras, thermal imaging devices, or environmental sensors. Payloads 223 enhance the versatility of the UAV 110 by enabling data collection, surveillance, or specific mission-related tasks. The type and configuration of payloads 223 can vary based on mission requirements.

Storage of Telemetry Data 225 stores historical telemetry data, enabling post-mission analysis and diagnostics. It also assists in tracking the performance and health of the UAV 110 over time. In one another embodiment, the storage of telemetry data 225 stores real-time flight parameters, including predictions and variables used for predictions. The Storage of Flight Mission 224 stores mission plans, waypoints, and instructions, ensuring that the UAV 110 has access to the necessary guidance and waypoints during its flight.

The Communication Unit 226 facilitates bidirectional communication between the UAV 110 and the Ground Control Station 120 or Flight Control Center 130. The Communication Unit 226 facilitates real-time data exchange, including telemetry data, mission commands, and status updates. The Communication Unit 226 ensures seamless coordination and information flow between the UAV and the control centers.

The Ground Control Station (GCS) 120 facilitates multiple functions for efficient UAV operations. The GCS 120 acts as a central hub for communication and control, enabling seamless coordination of UAV 110 missions. The GCS 120 includes a GCS controller 230, a GCS communication module 231, and GCS sensors 232. The GCS controller 230 oversees mission planning, telemetry data reception, and communication with the UAV 110.

In one embodiment, the GCS 120 functions as a communication interface for transmitting mission instructions, telemetry data, and status updates between the operator and the UAV 110. Bi-directional communication ensures that mission objectives are effectively conveyed, and real-time feedback is received, enhancing mission control and situational awareness.

Furthermore, the GCS 120 serves as a maintenance hub for UAVs. It allows for various maintenance tasks, including configuring UAV settings, diagnosing and rectifying issues, and rapidly uploading or downloading mission-related data. Such capability streamlines operational efficiency by minimizing downtime and ensuring that UAVs are optimally configured and maintained.

The GCS 120 also facilitates managing UAV energy levels. In one embodiment, the GCS 120 provides a platform for recharging UAVs, ensuring that UAVs are powered up and ready for subsequent missions. Recharging capability extends the operational availability of UAVs and reduces the need for manual battery replacement.

Moreover, the GCS 120 functions as a landing and take-off platform, further contributing to mission efficiency and safety. UAVs can safely land and take off from the GCS 120, enhancing precision and control during these critical phases of mission execution.

The GCS 120 is configured to provide protection from adverse weather conditions. In an embodiment, the GCS 120 serves as a sheltered environment where UAVs can be safely stored and operated, shielding them from environmental factors such as rain, snow, or extreme temperatures. The protection provided by GCS 120 ensures that the UAVs are preserved and ready for deployment even in challenging weather scenarios.

The GCS Controller 230 is the central processing unit within the Ground Control Station 120. It manages mission planning, execution, and communication with the UAV 110. The GCS Controller 230 interprets operator commands, translates such commands into mission parameters, and coordinates the UAV 110 actions. The GCS Controller 230 serves as the operator's interface for mission planning and monitoring.

The GCS Communication Module 231 enables data exchange between the Ground Control Station 120 and the UAV 110. The GCS Communication Module 231 ensures that mission instructions, telemetry data, and status updates can be transmitted and received in real-time. The GCS Communication Module 231 establishes a robust and secure communication link, allowing operators to control the UAV remotely. In an embodiment, when the FCC 130 is a dedicated server, the GCS communication module is also utilized to communicate with the FCC 130.

GCS Sensors 232 are sensors installed within the GCS 120 to gather local environmental data. These sensors can include weather sensors, atmospheric pressure sensors, or temperature sensors. The data collected by GCS Sensors 232 can be used to assess local conditions and weather at the Ground Control Station's location, providing valuable information for mission planning and execution.

The FCC 130, includes various components. In an embodiment, the FCC 130 includes a Mission Planning Unit 240, a Mission Control Unit 241, a Weather Analysis Unit 242, an Operation Optimization Unit 243, a data storage facility 244, and communication interfaces 245. The FCC 130 is utilized for comprehensive mission planning, real-time mission control, weather analysis, operational optimization, data storage, and communication with all subsystems.

The Mission Planning Unit 240 is responsible for creating mission plans, defining waypoints, and optimizing flight paths. The Mission Planning Unit 240 takes into account mission objectives, weather conditions, and energy constraints to design efficient and safe flight routes. The Mission Planning Unit 240 collaborates with other units in the FCC 130 to ensure that mission plans are executed successfully.

The Mission Control Unit 241 is configured for real-time mission control and monitoring. The Mission Control Unit 241 receives telemetry data from the UAV 110, assessing its status and performance during flight. The Mission Control Unit 241 can make adjustments to the mission plan, alter waypoints, or even initiate return-to-base procedures if necessary. The Mission Control Unit 241 ensures that missions remain on track and can respond to unexpected events. In one embodiment, the Mission Control Unit 241 controls data from Energy Management Unit 222, including power consumption for each part of the UAV during the flight.

The Weather Analysis Unit 242 is configured for gathering, analyzing, and interpreting weather data from Data Sources 140. The Weather Analysis Unit 242 evaluates information such as wind speed, wind direction, atmospheric pressure, temperature, and humidity. Weather data for assessing weather conditions along the UAV's flight path. The Weather Analysis Unit 242 provides real-time updates to optimize flight plans and avoid adverse weather conditions.

The Operation Optimization Unit 243 leverages real-time data and predictive models to optimize operations of the UAV 110. The Operation Optimization Unit 243 works in coordination with the Mission Planning unit 240.

Within Data Sources 140, the Weather Data 250 component serves as a primary information source. The Weather Data 250 includes data from various weather stations, meteorological databases, and environmental sensors. The Weather Data 250 provides real-time and historical information related to weather conditions, such as wind speed, wind direction, atmospheric pressure, temperature, and humidity. The Weather Data 250 is updated and facilitates mission planning by helping the system adapt to changing weather conditions during flight.

Data Sources 140 further includes Terrain Data 251. Terrain Data 251 includes geospatial information, such as elevation maps, landforms, and obstacle data relevant to the UAV's flight path. Terrain data includes information about flight regulations in different zones, for example restricted flight areas or areas with limited altitude or speed of flights. Terrain Data 251 assists in planning missions over varied terrains, ensuring that the UAV 110 can navigate safely and efficiently. The Terrain Data 251 aids in obstacle avoidance, altitude adjustments, and overall route optimization.

External Telemetry Data 252 is an information source that complements the system's internal telemetry data. External Telemetry Data 252 gathers telemetry data from external sources, such as other UAVs, aircraft, or ground-based telemetry sources. The external telemetry data 252 can include information on nearby airspace traffic, environmental conditions, or mission-related data shared among collaborative UAVs. External Telemetry Data 252 enhances situational awareness and safety by providing a broader context for mission planning and execution.

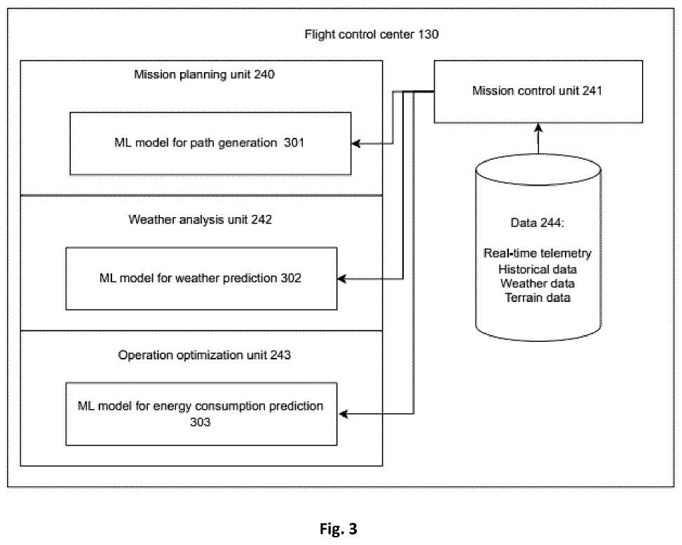

FIG. 3 shows a block diagram of the Flight Control Center 130, in accordance with one embodiment. As depicted, several components of Flight Control Center 130 are implemented using machine learning models to enhance the system's energy-aware flight mission planning and control capabilities. The FCC 130 includes multiple units, including the Mission Planning Unit 240, the Weather Analysis Unit 242, and the Operation Optimization Unit 243, each equipped with specific machine learning models.

Mission Planning Unit 240 determines the paths for UAV missions. In one embodiment, the path can be predefined. In one embodiment, the flight mission may have variability, where the flight mission for the UAV can include several predefined paths and predefined rules by which the UAV switches between trajectories depending on flight parameters.

In an embodiment, the Mission Planning Unit 240 incorporates a sophisticated path planning algorithm that dynamically considers the momentary energy expenditure model and predicted weather conditions at every point within the 3D space. The path planning algorithm enables the generation of the primary flight path, accounting for the estimated energy consumption along the trajectory. Additionally, the Mission Planning Unit 240 is configured to formulate multiple alternative paths, including options to return to base, initiate an emergency landing at designated spots, or explore alternative routes. These alternative paths are systematically generated and can be presented to the user for manual selection or automatically applied based on real-time conditions, enhancing the system's adaptability and ensuring optimal mission outcomes. According to an embodiment, the Mission Planning Unit 240 utilizes an advanced approach rooted in dynamic programming (DP) and 3D grids to optimize the UAV's flight path. In this embodiment, the mission planning unit constructs a 3D grid representing the airspace, with each grid cell denoting a specific spatial location. The algorithm initiates by simulating multiple potential flight paths, generating several possibilities across the grid. In one embodiment Mission Planning Unit 240 generates all possible flight paths and filters paths by parameters and limitations, like distance, altitude, velocity and other factors, corresponding to geographical location and UAV design. For each grid cell, the algorithm estimates the optimal power consumption based on the UAVs energy model and predicted weather conditions, incorporating factors such as wind speed, atmospheric pressure, and temperature. Using dynamic programming principles, the algorithm iteratively refines these simulated paths, evaluating the total energy expenditure associated with each path. Paths that consume more energy than the existing trajectory are discarded, while paths demonstrating energy efficiency are further explored and refined. Such an iterative process continues until the algorithm identifies the optimal flight path that minimizes energy consumption while adhering to safety and mission constraints. The utilization of dynamic programming and 3D grids enables the mission planning unit to systematically explore and evaluate an extensive range of flight scenarios, ensuring that the selected path aligns with the UAV's energy-aware objectives and environmental conditions.

In one embodiment, the Mission Planning Unit 240 incorporates a ML model for path generation 301. The ML model for path generation 301 is designed to generate optimal flight routes based on a multitude of parameters, including but not limited to predicted weather parameters. By analyzing forecasted weather conditions, terrain data, and historical flight data, the ML model for path generation 301 calculates an efficient route that minimizes energy consumption while meeting mission objectives. The ML model for path generation 301 ensures that UAVs follow paths optimized for energy efficiency.

In one embodiment, Reinforcement Learning (RL), including algorithms like Deep Q-Networks (DQN), is utilized in the ML model for path generation 301. The RL-based model learns optimal flight paths through interaction with the environment, receiving rewards and penalties based on its actions. For example, the RL-based model can be trained to navigate UAVs through dynamic weather conditions while minimizing energy consumption.

In another embodiment, Convolutional Neural Networks (CNN) are employed in the ML model for path generation 301, primarily for image-based path generation. CNN-based model processes terrain and weather data in image formats to identify obstacles, optimal routes, and energy-efficient flight paths. Input images may include terrain maps, real-time weather radar, and satellite imagery.

In an embodiment, Long Short-Term Memory networks (LSTM) models are used in the path generation model 301 for sequence-based path generation. These LTSM-based models process historical and real-time telemetry data, including UAV position, wind speed, and atmospheric pressure, to predict optimal flight paths for the near future.

The input format for the ML model for path generation 301 comprises a combination of data sources, including: high-resolution terrain maps or elevation data covering the designated flight area, real-time weather parameters, such as wind speed, wind direction, atmospheric pressure, temperature, and humidity, UAV telemetry data encompassing the current position, altitude, speed, and payload status.

For instance, the input data may be structured as follows: Terrain Data (Grid-based elevation map), Weather Data (real-time feed), Telemetry Data (live telemetry stream). In one embodiment, weather data represents a 3D field with determined weather parameters in each point of the 3D grid in the flight area. The ML model 301 can output the optimized flight path for the UAV, represented as a series of waypoints, coordinates, or a path vector to ensure minimal energy consumption and obstacle avoidance. For example:
Waypoints: [(latitude1, longitude1), (latitude2, longitude2), . . . , (latituden, longituden)]
Path Vector: [x1, y1, z1, x2, y2, z2, . . . , xn, yn, zn]

In another embodiment, the path vector can determine a differential change in coordinate value. In this case the model determines each next path point as a displacement from the previously generated point.

The Weather Analysis Unit 242 comprises a ML model for weather prediction 302, which leverages historical weather data, real-time data from UAVs and GCSs, and information from Data Sources 140. The ML model for weather prediction 302 employs advanced machine learning algorithms to predict weather parameters within the flight mission area. By analyzing and forecasting factors, the ML model for weather prediction 302 provides real-time weather prediction updates for adaptive mission planning. The weather prediction updates enable the system to proactively adjust mission parameters in response to changing weather conditions, ensuring safe and energy-efficient UAV operations.

In different embodiments, various machine learning algorithms are utilized for weather prediction. In one embodiment, Recurrent Neural Networks (RNNs) are employed to capture sequential dependencies in weather data. The RNN-based ML model for weather prediction 302 can effectively predict parameters like wind speed, wind direction, and temperature, taking into account their temporal variations.

In another embodiment, a Random Forest algorithm is used for weather prediction. This ensemble learning method can handle both numerical and categorical data, making it suitable for predicting diverse weather parameters.

In another embodiment, feed-forward neural network is used for weather prediction.

For image-based weather prediction, such as cloud cover analysis, Convolutional Neural Networks (CNNs) can be utilized.

The ML model for weather prediction 302 takes inputs in the form of: historical datasets containing historical weather observations, such as wind speed, wind direction, atmospheric pressure, temperature, humidity, and cloud cover; telemetry data from UAVs and ground control stations, providing up-to-the-minute weather-related measurements; meteorological measurements from weather stations, which contribute additional context for accurate predictions. For example, data representing a wind can be in a form of 3D vector, where in each value of the vector variables is a value of the wind speed.

The output of the ML model 302 includes real-time weather forecasts, providing data on parameters such as:
Wind Speed: Predicted wind speed values (e.g. in meters per second).
Wind Direction: Predicted wind direction (e.g. in degrees relative to true north).
Atmospheric Pressure: Predicted atmospheric pressure (e.g. in millibars).
Temperature: Predicted temperature (e.g. in degrees Celsius).
Humidity: Predicted relative humidity (e.g. as a percentage).
Cloud Cover: Predicted cloud cover conditions (e.g. represented as a fraction or percentage).

In one embodiment using RNNs, the ML model 302 is trained on historical weather data spanning several years. The training dataset includes sequential weather observations, ensuring that the model learns to capture the temporal dependencies of weather patterns. During training, the RNN processes historical data and optimizes its internal parameters to minimize the difference between predicted and actual weather conditions. As a result, the ML model 302 becomes proficient in forecasting weather parameters, making it invaluable for planning UAV flight missions under variable weather conditions.

In the context of UAV missions, weather conditions can exhibit considerable variation depending on altitude levels. To address this challenge, the ML model for weather prediction 302 is equipped with the capability to model altitude-specific weather layers. Such a feature enhances the precision of weather forecasts for UAV operations conducted at varying heights.

In one embodiment, the altitude-specific weather modeling is segmented into distinct layers corresponding to different flight levels. These layers can be defined at specific altitude intervals or breakpoints, allowing the model to capture the nuances of weather conditions at various heights.

Ground Level (0-100 meters): Weather conditions near the Earth's surface, which may include ground-level winds, temperature, and humidity.

Low-Altitude Layer (100-500 meters): Predictions for low-altitude layers can encompass changes in wind speed and direction, temperature gradients, and cloud cover within this specific altitude range.

Mid-Altitude Layer (500-1000 meters) focuses on weather variations that occur at intermediate altitudes, providing insights into potential atmospheric turbulence or other conditions relevant to the UAV's path.

High-Altitude Layer (above 1000 meters): Predictions for the highest layer capture conditions at elevated flight levels that includes considerations for strong winds, temperature drops, and potential encounters with cloud formations.

The altitude-specific weather modeling relies on comprehensive data sources, including historical weather records and atmospheric measurements taken at various altitudes. Additionally, real-time telemetry data from UAVs, ground control stations, and external sensors contribute to altitude-specific forecasts.

By offering altitude-specific weather predictions, the ML model 302 empowers flight control systems to make informed decisions based on the altitude at which the UAV is operating. For example, if the UAV encounters unfavorable conditions at a particular altitude layer, flight planners can dynamically adjust the mission parameters to optimize safety and efficiency. Altitude-specific weather prediction significantly enhances the adaptability of UAV missions, allowing for effective navigation through diverse weather conditions encountered at varying heights.

The Operation Optimization Unit 243 includes a ML model for energy consumption prediction 303 that offers multifaceted capabilities to enhance mission efficiency and safety. In one embodiment, ML model for energy consumption prediction 303 determines whether a given flight route can be safely completed with the available battery charge. By analyzing data from the energy management unit 222, historical flight data, and real-time telemetry data, the ML model for energy consumption prediction 303 evaluates energy requirements and assesses the feasibility of completing the mission within existing power constraints. The ML model for energy consumption prediction 303 embodiment takes into account parameters such as the current battery charge of the UAV, flight mode (including speed, acceleration, altitude, and payload status), and the predicted weather conditions from the ML model for weather prediction 302.

According to an embodiment, the ML model for energy consumption prediction 303 is configured to provide a detailed prediction of battery consumption for each point along the 3D grid that represents the UAV's flight path. By accurately estimating battery usage at each grid cell, the model contributes to the system's ability to dynamically adapt to evolving mission scenarios and ensure the efficient utilization of energy resources. Each grid cell is treated as a potential waypoint for the UAV, and the model generates predictions for energy usage based on the specific configurations of the UAV, such as speed, acceleration, altitude, and payload. Accordingly, in an embodiment, the prediction of battery consumption for each point utilizes the same 3D grid that represents the UAV flight path, but the cells are described with battery-associated data. The model 303 is extensively trained using historical data and real-time telemetry information, ensuring it can make accurate predictions under varying conditions. The output of the ML model for energy consumption prediction 303 represents a comprehensive map of anticipated battery consumption values across the 3D grid. The battery consumption map can be further used as an input for the mission planning unit 240. It enables the mission planning unit 240 to assess the energy requirements for different segments of the planned flight path, aiding in the selection of the most energy-efficient trajectory.

The model 303 monitors the battery charge level of the UAV and predicts how battery charge will evolve throughout the mission. By analyzing energy consumption patterns in relation to the flight mode and expected weather conditions, the model 303 can determine whether the battery charge of the UAV will safely last until the mission's completion. Such a determination helps prevent situations where the UAV risks running out of power before reaching its destination.

In cases where the model 303 anticipates potential battery depletion issues, the model 303 can dynamically recommend adjustments to the flight mode. For example, the model 303 can suggest reducing speed, altering the altitude, or optimizing payload settings to conserve energy and extend the operational range of the UAV. These recommendations are communicated to the mission control unit 241 for implementation in real-time.

Additionally, the ML model for energy consumption prediction 303 offers an alternative embodiment where it determines the optimal flight mode, generating decisions regarding flight speed, acceleration, altitude, payload configurations, and more. By considering various parameters and their impact on energy consumption, the model 303 dynamically adjusts the flight characteristics of the UAV to maximize energy efficiency. Such an adaptive approach ensures that the UAV operates in the most energy-efficient manner possible, optimizing mission outcomes while preserving battery life. In another embodiment, the energy consumption prediction model 303 evaluates various flight parameters such as speed, acceleration, altitude, and payload status, taking into account both real-time telemetry data from the energy management unit 222 and the predicted weather conditions from the ML model for weather prediction 302.

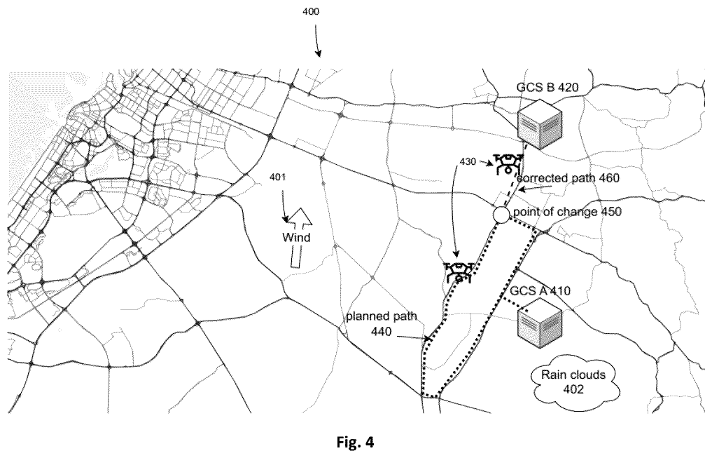

FIG. 4 shows a schema of the UAV path adjustment during a flight mission, providing an operator interface 400 for monitoring UAV positions, Ground Control Station (GCS) status, and real-time terrain and weather data. FIG. 4 includes a terrain map displaying key weather information, such as rain clouds 402 and wind speed and direction 401. In alternative embodiments, additional weather data layers, such as temperature, can be superimposed onto the map.

FIG. 4 depicts two Ground Control Stations: GCS A 410 and GCS B 420, along with multiple UAVs 430 in operation. Each UAV 430 is engaged in a predefined flight mission, following a planned path 440 that originates from GCS A and later curves back.

At a critical point marked as the point of change 450, the Flight Control Center (FCC) 130 assesses the prevailing weather conditions and evaluates the remaining battery charge of UAV 430. In one embodiment, the FCC 130 may determine that the weather conditions, such as unfavorable wind patterns or rain clouds, pose a risk to the safe return of the UAV to GCS A 410. Additionally, the FCC 130 monitors the battery level of the UAV to ensure a safe return to GCS A 410. The point of change 450 is a location of the UAV, when the system breaks the predefined flight mission and changes the path. There can be several points of change during the flight, if the weather conditions change rapidly.

In response to the assessment, the Flight Control Center 130 generates a corrected flight path 460 for the UAV 430, redirecting the UAV 430 towards GCS B 420, which is considered a safer destination under the current conditions. The corrected path is calculated to optimize the UAVs energy consumption, taking into account the new destination and the anticipated weather conditions.

The mission control unit within the FCC 130 issues a command to the UAV 430, instructing it to follow the corrected path 460 to reach GCS B 420 safely. Real-time adjustment ensures that the flight mission of the UAV 430 remains both efficient and secure, adapting to dynamic weather conditions and conserving energy. The ability to reevaluate flight paths and make real-time adjustments enhances mission safety and ensures that UAVs reach their intended destinations efficiently, even in the face of unexpected weather challenges.

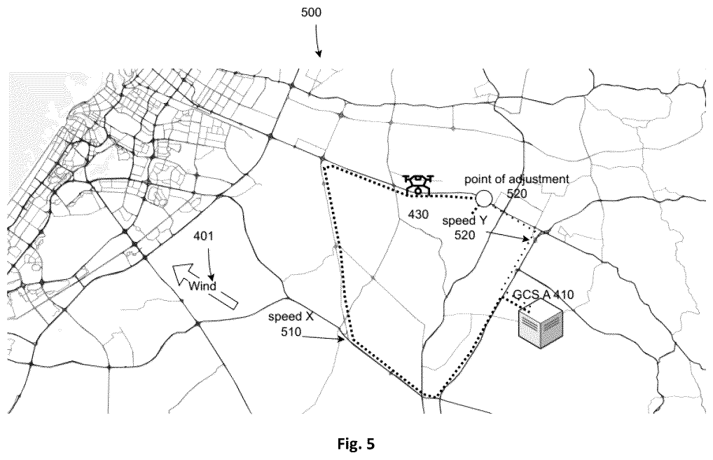

FIG. 5 shows a schema of adaptive flight mode adjustment during a UAV flight mission. FIG. 5 features terrain data, including wind speed and direction401, and illustrates a UAV 430 engaged in a mission that departs from GCS A 410 and returns along the same path.

In this scenario, the UAV 430 initially follows the predefined flight path with a set speed, denoted as X 510. However, at an adjustment point 520 along the path, the system anticipates that the remaining battery charge may not be sufficient to complete the mission safely at the current speed. The point of adjustment 520 is a location of the UAV, where the system breaks the predefined flight mission and changes the flight mode. There can be several points of adjustment during the flight, if the weather conditions change rapidly.

To ensure mission completion without risking a depleted battery, the Flight Control Center (FCC) 130 makes a real-time adjustment to the flight mode of the UAV 430. At the point of adjustment 520, the speed is reduced to a lower value, denoted as Y 530. Such an adjustment optimizes energy consumption, allowing the UAV 430 to continue its mission at a pace that conserves energy and ensures its return to the starting point.

FIG. 5 exemplifies the system's capability to dynamically adjust flight parameters, such as speed, in response to real-time data and energy management considerations.

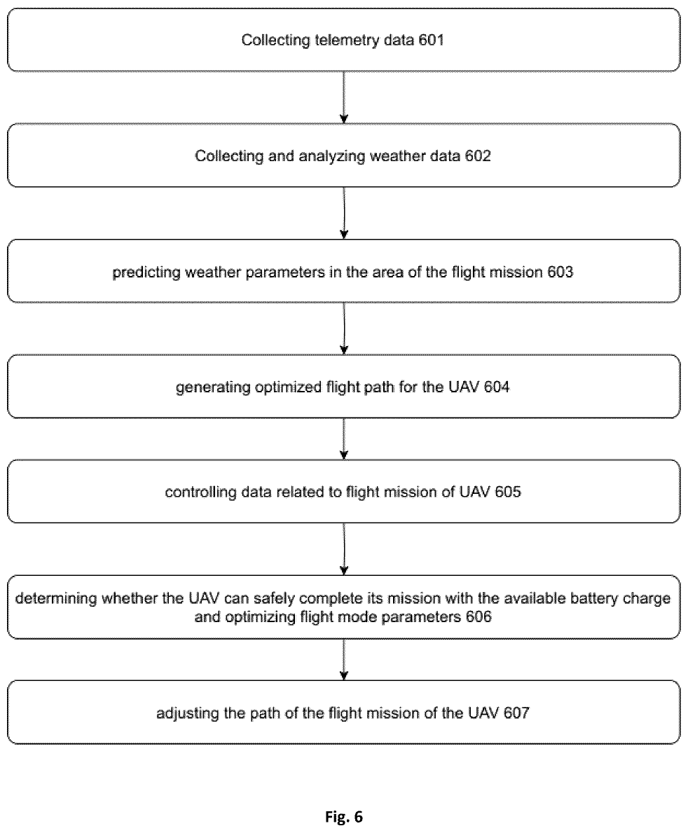

FIG. 6 shows a flowchart of a method for energy-aware flight mission planning and control in UAVs. In particular, FIG. 6 presents a detailed flowchart of the method for energy-aware flight mission planning and control in unmanned aerial vehicles. According to an embodiment, at 601, telemetry data is collected from the UAVs. The telemetry data comprises information about various aspects of the UAVs' operation, including but not limited to energy consumption, flight mode, and real-time positional data.

According to an embodiment, at 602, real-time weather data is collected and analyzed. 602 thus provides insights into the current weather conditions, including factors such as wind speed, wind direction, atmospheric pressure, temperature, humidity, and precipitation. The weather analysis serves as a foundation for making informed decisions during flight missions.

According to an embodiment, at 603, the machine learning model for weather prediction analyzes historical data, real-time data from UAVs and Ground Control Stations, and data from external sources, such as weather stations and environmental sensors and predicts weather parameters in the area of the flight mission accurately.

According to an embodiment, at 604, the mission planning unit 240 generates optimized flight paths for the UAVs, utilizing the collected telemetry data and weather analysis. Dynamic programming techniques are utilized to ensure that the flight paths are energy-efficient and responsive to dynamic weather conditions.

At 605, the flight mission is executed by the UAV, and data related to the flight mission is controlled. The flight mission control includes monitoring and control of the telemetry data of the UAV. The telemetry data includes information related to UAV energy consumption, flight mode, and position.

According to an embodiment, at 606, the machine learning model for energy consumption prediction determines whether the UAV can safely complete its mission with the available battery charge. The machine learning model for energy consumption relies on data from the UAVs' energy management units. In an embodiment, the machine learning model for energy consumption prediction optimizes various flight mode parameters, including speed, acceleration, altitude, and payload configuration, based on energy consumption predictions.

According to an embodiment, at 607, the method includes adjusting the path of the flight mission, including altitude of the UAV, during the flight mission based on weather predictions. At 607, embodiments ensure that the UAV operates optimally, taking into account altitude-dependent weather conditions. The adjustment may involve redirecting the UAV to a different Ground Control Station or initiating a stop for recharging and protection from adverse weather risks.

After the mission is completed, the machine learning model for weather prediction and the machine learning model for energy consumption prediction are retrained offline, taking into account new data collected during the completed mission.

1. A method for energy-aware flight mission planning and control in Unmanned Aerial Vehicles (UAVs), comprising:
collecting telemetry data from UAVs, weather data related to flight mission location, and terrain data of flight mission location from data sources;
training a plurality of machine learning models (MLs) based on the collected data including a mission planning ML model, a weather prediction ML model, and an energy consumption ML model, wherein each of the plurality of ML models is configured to generate a prediction;
planning a flight mission for a first UAV based on the collected data and predictions of the plurality of machine learning models, the mission commencing from a first ground control station;
controlling telemetry parameters of the first UAV during the flight mission, the telemetry parameters including energy consumption; and
adjusting the flight path of the first UAV based on the controlled telemetry parameters and predictions to complete the flight mission.

2. The method of claim 1, wherein the adjusting the flight path of the first UAV further comprises redirecting the first UAV to a second ground control station for completing the mission.

3. The method of claim 1, wherein the adjusting the flight path of the first UAV further comprises initiating a stop at a second ground control station for recharging the first UAV.

4. The method of claim 1, wherein the adjusting the flight path of the first UAV further comprises adjusting the position of the first ground control station.

5. The method of claim 1, further comprising collecting telemetry data from a second UAV, and using the collected telemetry data from the second UAV to adjust the flight mission of the first UAV.

6. The method of claim 1, wherein the collected data includes data related to wind speed, wind direction, atmospheric pressure, temperature, humidity, terrain elevation and terrain zones.

7. The method of claim 1, wherein the mission planning unit employs a dynamic programming approach for optimizing flight paths.

8. The method of claim 1, wherein the energy consumption ML model includes a sub-model for determining the feasibility of completing the mission with available battery charge.

9. The method of claim 1, wherein the energy consumption ML model includes a sub-model for optimizing flight mode parameters, including at least one of speed, acceleration, altitude, or payload configuration.

10. The method of claim 1, further comprising adjusting the altitude of the first UAV during the flight mission based on weather prediction specific to different altitude levels.

11. The method of claim 1, wherein the telemetry data from UAVs comprises motor power for wind extraction.

12. A system for energy-aware flight mission planning and control in unmanned aerial vehicles (UAVs), comprising:
a flight control center, including:
a mission control unit configured to control telemetry data from a first UAV and manage mission parameters for the first UAV,
a mission planning unit configured to plan flight missions for the first UAV based on weather data, terrain data, and energy consumption predictions,
a weather analysis unit configured to analyze real-time weather data and predict weather conditions relevant to the flight missions, and
an operation optimization unit, configured to optimize flight mode parameters, including speed, acceleration, altitude, and payload configuration, using machine learning models;
data sources, comprising real-time weather data and terrain data;
a first ground control station configured to communicate with, recharge, and shield UAVs; and
a first UAV, configured to perform flight missions according to planned flight missions, adjust flight missions based on the telemetry data, the weather conditions, and the energy consumption predictions, and communicate with the first ground control station and the flight control center.

13. The system of claim 11, further comprising a second ground control station, wherein the flight control center is configured to redirect the first UAV to the second ground control station to complete a flight mission.

14. The system of claim 11, further comprising a second ground control station, wherein the flight control center is configured to initiate a stop on the second ground control station for recharging the first UAV during a flight mission.

15. The system of claim 11, wherein the first ground control station is configured to adjust its position.

16. The system of claim 11, further comprising a second UAV configured to collect telemetry data and communicate with the flight control center to adjust the flight mission of the first UAV.

17. The system of claim 11, wherein the mission planning unit implements a machine learning model for path generation that employs reinforcement learning techniques for optimizing flight paths.

18. The system of claim 11, wherein the mission planning unit implements a machine learning model for energy consumption prediction configured for determining the feasibility of completing the flight mission with available battery charge.

19. The system of claim 11, wherein the mission planning unit implements a machine learning model for energy consumption prediction configured for optimizing flight mode parameters, including at least one of speed, acceleration, altitude, or payload configuration.

20. The system of claim 11, wherein the mission planning unit implements a machine learning model for weather prediction configured to predict weather parameters specific to different altitude levels.
